(19) United States
(12) Patent Application Publication
(10) Pub. No.: US 2019/0149344 A1
(43) Pub. Date: May 16, 2019

(54) INTELLIGENT SEARCH SYSTEM FOR SERVICE COST AND METHOD THEREOF

(71) Applicant: Bespin Global Inc., Seongnam-si (KR)

(72) Inventors: Jong Lok KIM, Seoul (KR); Tae Ha HONG, Yongin-si (KR); Sung Soo KIM, Yongin-si (KR)

(73) Assignee: Bespin Global Inc., Seongnam-si (KR)

(21) Appl. No.: 16/143,942

(22) Filed: Sep. 27, 2018

(30) Foreign Application Priority Data
Nov. 10, 2017 (KR) 10-2017-0149127

(51) Int. Cl. H04L 12/14; H04L 29/08; G06F 17/30; G06Q 30/02

(52) U.S. Cl. CPC H04L 12/1421; H04L 12/1428; G06Q 30/0283; G06F 17/30952; H04L 67/1002

(57) ABSTRACT

A search system including: a data management unit for collecting raw cost data including information on a usage amount of the time unit for cloud service resources, a usage log, and cost thereby provided from the cloud service to extract each item of billing history included the raw cost data as an item, setting the item as a search key for cost search, and classifying the cost into each item of the billing history to generate cost data; a cost data unit for storing the cost data; a cost search application for providing an interface for cost search; a filtering unit for setting the search key for each item for cost search, and filtering the result searched from the cost data unit; and a search unit for generating a cost report based on the cost data included in the filtered searched result.

### CROSS REFERENCE TO PRIOR APPLICATION

This application claims priority to Korean Patent Application No. 10-2017-0149127 (filed on Nov. 10, 2017) which is hereby incorporated by reference in its entirety.

### BACKGROUND

The present disclosure relates to an intelligent search system for service cost and a method thereof, and more particularly, to an intelligent search system and a method thereof for calculating the cost of service resources used for service provision using intelligent search.

A cloud system provides an environment for accessing a virtual server through a terminal and freely implementing a desired service.

The cloud system is a service for renting some storage spaces to an individual to enable an individual user to store data in an allocated space by accessing through a terminal, and a service for providing an infra such as a basic computing environment or a network service, etc.

The cloud system includes a platform service for providing a platform or solution for computer use, and also, a software service for enabling application software to be used over a network.

The cloud system is used in various applications such as mobile applications, games, shopping malls, and social network services.

In such a cloud system, a user who uses or provides the service can use the resource without time and space restrictions, and can also check the usage state in real time.

The cloud system provides the service to perform the same role as an existing physical server.

When providing a user with a predetermined internet service using such a cloud system, the service provider spends a certain amount of money in using the cloud system.

The cost of the cloud service is calculated depending upon the capacity of the virtual server to be used, the size of the resource to be used, the frequency with which the resource is used, the traffic capacity to the resource, etc.

There is a problem in that the resources used for service provision are not simply used one or two times, but when one resource is used, other resources related to the corresponding resource are also used by interlocking with each other, such that the cost is not simply processed and the cost is greatly increased depending upon the relationship between the resources.

The cloud system, however, does not provide details of the cost of cloud services and only provides summarized bill in the form of invoice, such that it is limited to manage the cost because it is not possible to confirm detailed cost information for cloud service usage, and to know the cost according to the usage amount until the cost from the cloud system are charged.

In addition, there is a problem in that the format of cost data differs for each provider of the cloud system, such that it is not possible to integrally manage the cost.

### RELATED ART DOCUMENT

### Patent Document

(Patent Document 1) Korean Registered Patent No. 10-1146742 (May 17, 2012)

### SUMMARY

The present disclosure relates to an intelligent search system for service cost and a method thereof, and more particularly, an intelligent search system for service cost and a method thereof, which search for the cost of the service resources for the internet service provided based on the cloud service through the intelligent search, and easily manage the cost according to the use of the service resources through cost analysis.

An intelligent search system for service cost in accordance with the present disclosure includes, as the search system for searching for and managing cost generated by providing service resources based on a cloud service, a data management unit for setting a search key for cost search by collecting raw cost data including information on a usage amount of the time unit for cloud service resources, a usage log, and cost thereby from the cloud service and generating cost data by classifying cost for each of billing history; a cost data unit for storing the cost data; a cost search application for providing an interface for cost management and cost search including a search UI; a filtering unit for setting a search item according to a search condition input through the search UI, and filtering the result searched from the cost data unit according to the search condition; and a search unit for generating a cost report based on the filtered searched result.

The data management unit includes a data optimization engine for excluding items not used for cost search from the raw cost data, and generating cost information by classifying and summing the cost data of the time unit by the same item according to billing history; and a search data manager for generating a search key for each item for cost search by classifying the billing history of the raw cost data for each item or each day, and storing it in the cost data unit by regenerating the cost data for cost search.

The data optimization engine optimizes the capacity of the cost data by excluding the item not used for cost search, and the search data manager minimizes data to be searched by excluding redundancy data.

The search data manager generates search key data by combining the relevant items with respect to the item, and adds a new search key to the search key data by comparing it with the previously generated and cumulatively stored search key data.

The search data manager extracts the item and an additional information item for the item to store it together with the cost information therein.

The search data manager extracts cost information of a combination of the same items as the search key data by day in the daily cost of the cost information, and stores the cost and usage amount information of the corresponding data in a calendar type table classified into the item of month and day.

The search data manager stores the cost data by combining items having mutual relevance based on a predetermined correlation with respect to the item.

The filtering unit extracts a unique search key for a search key matching the item by searching for an item included in the search condition from search key data, and extracts daily cost data in response to the unique search key from the cost data.

When the search condition is input, the search unit automatically searches for and displays another item having the correlation with the item of the search condition from the item information for search, and when a new item is selected, the search unit automatically searches for and displays another item having the correlation with the new item.

A method of an intelligent search system for search cost of the present disclosure includes collecting raw cost data of a cloud service; calculating cost information by analyzing the raw cost data, and optimizing cost data by excluding an item not related to cost search; generating search key data by a combination of items for searching for the raw cost data;

storing the cost information of a combination of the same items in response to the search key as cost data; extracting the cost data by searching for an item from the search key data when a search condition for cost search is input; and generating and outputting a cost report according to search results.

The method of the intelligent search system for search cost further includes calculating daily cost for each of billing history by analyzing the raw cost data; registering a new search key by comparing the search key data with previously generated search key data; and setting a unique search key to the search key.

The cost data is stored in a calendar type table.

The intelligent search system for service cost and the method thereof in accordance with the present disclosure configured as described above can search for raw cost data according to the use of service resources to analyze the cost and calculate the cost data for each item and each day according to the use of resources through the correlation of the cost by the intelligent search, thus easily calculating the cost according to the use of the service resources.

In addition, the present disclosure can minimize redundancy of cost data, and optimize the size of cost data to minimize the capacity for storing the cost data and quickly searching for the cost according to conditions, thus enhancing the convenience and efficiency of cost management.

### BRIEF DESCRIPTION OF THE DRAWINGS

FIG. 1 is a block diagram illustrating a cloud service-based service provision system and a search system thereof in accordance with the present disclosure.

FIG. 2 is a block diagram illustrating an intelligent search system for service cost in accordance with the present disclosure.

FIG. 3 is a flowchart illustrating a method for processing the cost data of the intelligent search system for service cost in accordance with the present disclosure.

FIG. 4 is a flowchart illustrating a method for searching for the cost according to the conditions of the intelligent search system for service cost in accordance with the present disclosure.

### DETAILED DESCRIPTION

The advantages and features of the present disclosure and the method for achieving them will become apparent with reference to the embodiments described in detail below with reference to the accompanying drawings. The present disclosure can, however, be embodied in various forms and should not be construed as limited to the embodiments disclosed below; these embodiments are only provided so that this disclosure will be thorough and complete and will fully convey the scope of the disclosure to those skilled in the art to which the present disclosure pertains; and the present disclosure is only defined by the scope of the claims. Like reference numerals refer to like elements throughout the specification. The present disclosure provides a social network service by transmitting and receiving data to and from a plurality of terminals through a network by the server including at least one processor.

Hereinafter, the embodiments of the present disclosure will be described in detail with reference to the drawings.

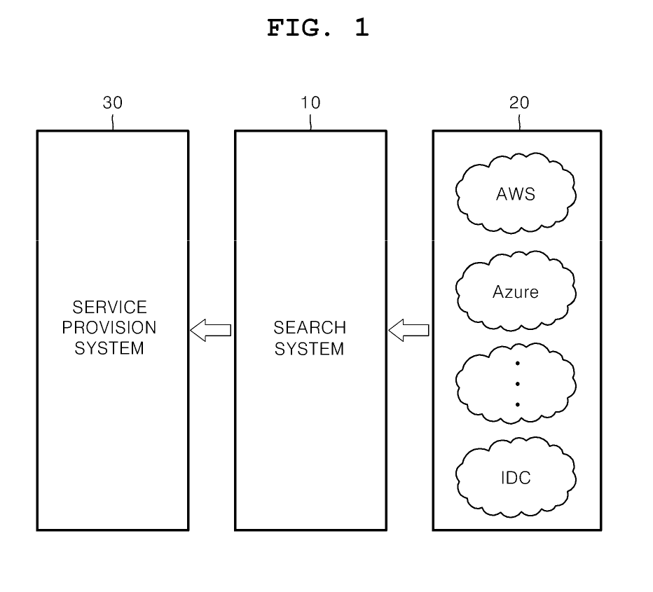

FIG. 1 is a block diagram illustrating a cloud service-based service provision system and a search system thereof in accordance with the present disclosure.

The cloud service 20 supports the execution of service provision-based system, that is, an infra, a platform, and software as well as a data storage space.

For example, the cloud service provides IDC services as well as various cloud services such as QWS, Azure, and Soft-layer.

The service provision system 10 is operated based on the cloud service 20, accumulates service resources based on an infra or a platform provided from the cloud service, and processes the service resources according to the service provision purpose to provide it to the user.

The search system 30 provides intelligent search to the service provision system.

The Intelligent Search is configured as a network of the respective conditions by grouping a combination of data that is not relevant or is difficult to have the relevance into one organism. In order to construct the conditions in the network form, it is necessary to collect data in a condition that is optimal for combining the data, to sort the collected data to remove redundant data, and to increase the search speed by minimizing the data to be searched. In addition, the linkage between the redundant data is determined to reduce the amount of data, but the relationship between them is maintained. Accordingly, a user can select a meaningful search condition by providing a guide for a relevant search condition to be selected next through an optimal route among data that can influence each other.

The search system 30 collects raw cost data from a cloud service provider through the intelligent search, provides quick search for a large amount of raw cost data, and simultaneously provides information for a relevant item upon the response to the search results.

The raw cost data is provided from the cloud service, and is to classify the cost according to the use of the cloud service by items. The raw cost data includes information on the usage amount of the time unit for the resource of the cloud service, the usage log, and the cost thereof. The raw cost data can be classified into the cost per item and also the cost per day.

The search system 30 processes a large amount of raw cost data through the intelligent search, analyzes the correlation of cost according to the relationship between the service resources, and searches and analyzes for the cost of the cloud service according to the use of the service resources of the service provision system 10 to calculate the cost data.

In addition, the search system 30 searches for the raw cost data and analyzes the raw cost data according to the usage amount and item to calculates the cost for each item or the daily cost, and optimizes the capacity of the cost data to quickly search for the cost satisfying a predetermined condition if necessary.

The service provision system 10 can easily search for, integrate, and manage the cost of the cloud service according to the use of the service resources through the search system 30.

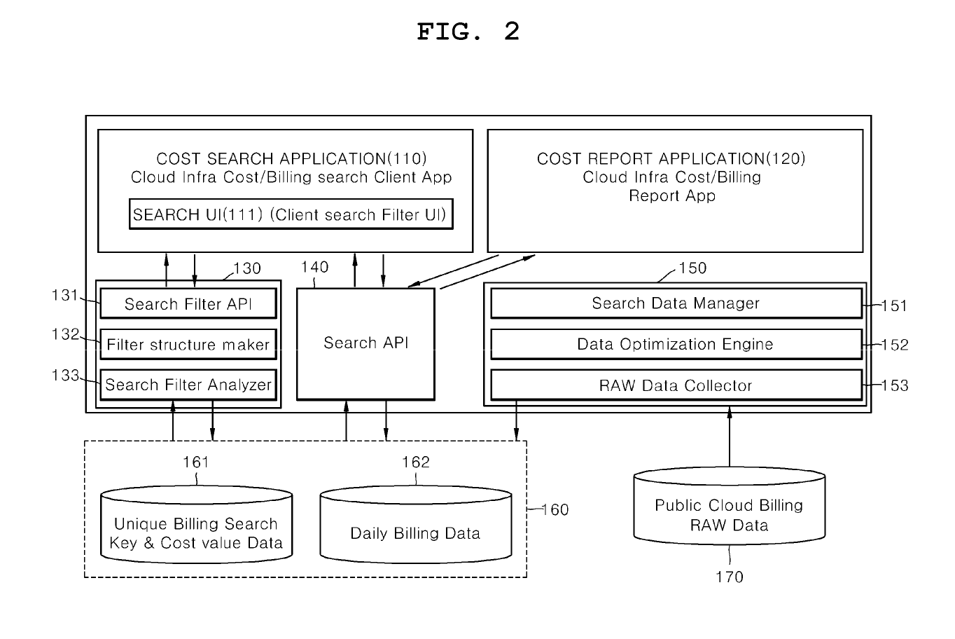

FIG. 2 is a block diagram illustrating an intelligent search system for service cost in accordance with the present disclosure.

As illustrated in FIG. 2, the search system 30 includes a cost search application 110 including a search UI 111, a cost report application 120, a filtering unit 130, a search API 140, a data management unit 150, a cost data unit 160, and raw cost data 170. The cost data unit 160 includes the search key data 161, and the daily billing data 162.

The search system 30 analyzes the raw cost data provided from the cloud service to classify it by item, sets a search key by the item to store it together with the cost value in the search key data 161, and stores the data on the daily billing cost corresponding to the search key in the daily billing data 162. The search system 30 stores the remaining except for data that is not used for the search among the raw cost data, and processes the redundant data to optimize the capacity of the cost data.

The data management unit 150 collects and analyzes the raw cost data to generate the cost data for each item or the daily cost data. Herein, the data management unit 150 includes a search data manager 151, a data optimization engine 152, and a raw data collector 153.

Meanwhile, the raw data collector 153 collects raw cost data for each cloud service. The raw cost data is provided by each cloud service provider in the form of OpenAPI or File, and includes information on the usage amount of the time unit for the resource of the cloud service, the usage log, and the cost thereof. The raw cost data can be provided from a plurality of cloud services, respectively, and the format can be different depending on the cloud service.

Herein, the raw data collector 153 collects various types of raw cost data from a plurality of cloud service providers, respectively.

Meanwhile, the data optimization engine 152 extracts items from the raw cost data, and generates cost information by generating item combinations according to the correlation between the items.

The item can be set from each item of the raw cost data, and used for cost search. For example, a cloud account for the cloud service, a resource ID, a usage region, etc. can be items, respectively.

The data optimization engine 152 sums the cost data of the time unit from the raw cost data into the daily cost data by the same item. In addition, the data optimization engine 152 excludes the additional items not related to the cost among the raw cost data, and generates daily cost data.

The cost data can generate cost data by combining the item and the cost information for the corresponding item based on the cost information for each item extracted from the raw cost data. In this time, the cost data can be generated based on each item, and can be also generated by combining a plurality of items.

The search data manager 151 minimizes the data to be searched and regenerates cost data as search data for intelligent search to store it in the cost data unit 160.

For the cost data for each cloud service provider and the daily cost data, the search data manager 151 extracts item elements having the correlation therebetween, for example, the search basic item and the product additional information item and combines the extracted data to store it as a search key therein.

TABLE 1
Billing Search Basic Item

| | | | | | | | | |
|---|---|---|---|---|---|---|---|---|
| Cloud | Customer | Cloud | Cloud | Usage | Resource | Invoice | Purchase | Product |
| vendor | ID | Account | Product | Region | ID | | Option | Additional |
| | | | | | | | | Information |

TABLE 2
Product Additional Information Item

| | | | | | | |
|---|---|---|---|---|---|---|
| OS | DataTransfer | Storage | Tag | Auto- | Server | Service |
| | | | | Scaling | Type | Group ID |

As illustrated in Tables 1 and 2, the search data manager 151 classifies items for search to combine additional information thereon.

When a unique record is extracted by a combination of items as illustrated in Tables 1 and 2, the search data manager 151 assigns a unique key value to the respective records. The search data manager 151 generates master data for cost search as the form combining a search key and a unique record.

The items extracted from the raw cost data and the items for additional information can be used as a search key for cost search.

The search data manager 151 classifies the optimized cost data by item or day and assigns a search key to each item so that the cost data can be searched to store it in the search key data 161. The search data manager 151 generates search key data through the items and the additional information items.

For example, the items can use a cloud provider, a cloud account, a cloud product, a usage region, a resource ID, invoice information, and a cloud purchase option as illustrated in Table 1. In addition, the additional information items can use DataTransfer, an OS, a Storage, a Tag, an Auto-Scaling, a Server Type, and a Service Group in order to specifically classify the cost according to the use of the cloud service.

The search data manager 151 generates search key data by a combination of items having relevancy.

For example, when it is desired to check the information on the cost of a specific usage region, the cost of the region A can be searched using the search key set for the region A of the usage region. In this time, the name of the region A can be a search key. In addition, when it is classified according to each usage region, the usage region can be a search key.

By setting a search key for each item, it is possible to search for information on a specific cost through a plurality of search keys. In addition, by using the relationship between the items, for example, the region A and the data such as the usage amount in the region A have the mutual relevancy, such that they are extracted together.

The search data manager 151 compares the newly generated search key data with previously generated and cumulatively stored search key data, and adds the new search key to the search key data except when the same search key is present. The search data manager 151 assigns a unique search key of the search key data to the new search key, and stores the search key and the cost value in the search key data 161.

The search data manager 151 extracts items and additional information items to store the search key together with the cost value therein, thus minimizing the data to be searched and searching depending upon the correlation therebetween.

In addition, the search data manager 151 separately separates the daily cost data for the daily cost corresponding thereto regarding the cost data for each item according to the search key to store it in the daily billing data 162 in the form of a calendar table of month and day forms.

TABLE 3

| | | | Initial | Last | | | | | |
|---|---|---|---|---|---|---|---|---|---|
| | | | Generation | Modification | | | | | |
| Search | Customer | Month | Date and | Date and | | | | | Monthly |
| Key | ID | Information | Time | Time | 1st | 2nd | . . . | 31st | Total |
| 1 | AAA | 2017 January | 2017 Jan. 2 | 2017 Jan. 2 | 0 | 15.1 | . . . | 18.4 | 542.6 |
| | | | 01:34:15 | 01:34:15 | | | | | |
| 2 | BBB | 2017 January | 2017 Jan. 1 | 2017 Jan. 9 | 32.3 | 29.5 | . . . | 33.5 | 921.9 |
| | | | 02:10:00 | 13:43:05 | | | | | |
| 3 | AAA | 2017 February | 2017 Feb. 1 | 2017 Feb. 2 | 21.3 | 22.3 | . . . | 25.8 | 710.4 |
| | | | 00:10:45 | 08:32:32 | | | | | |

. . .

| | | | | | | | | | |
|---|---|---|---|---|---|---|---|---|---|
| 100 | CCC | 2017 February | 2017 Feb. 1 | 2017 Feb. 23 | 100.5 | 87.4 | . . . | 112.6 | 2916.3 |
| | | | 05:23:15 | 15:27:30 | | | | | |

The search data manager 151 stores the sum of Tables 1 and in the calendar type table as in Table 3 together with the index information of the search key.

Based on the master data generated in advance, the search data manager 151 sorts the master data for cost search by day to sum the daily usage cost, and then stores it in the calendar type table. As the monthly and daily cost data are finally stored for each search item for cost search in the calendar type table, the search data manager 151 can quickly search for the cost of specific month and day for each cost item when performing the intelligent search.

In addition, when the same key value and the cost value are repeated, the search data manager 151 stores only the search key value and the cost value in the calendar type table, instead of describing all the repeated values, thus minimizing the data to be searched. Accordingly, as illustrated in the following Table 4, the search system can greatly improve the transmission/reception speed according to the search when the data is greatly compressed through optimization of the data search key value and data and the object to be searched is minimized to enable a quick search and optimize storage capacity.

TABLE 4

| | Data | | |
|---|---|---|---|
| Data Form | Capacity | Description | Effects |
| Billing RAW | 7 GB | Monthly Billing RAW data | |
| Data | | sample of AWS Cloud | |
| Primary | 840 MB | Sum Billing Data by time unit | Compressed |
| Processing | | into daily data and process | to 12% level |
| | | except for meaningless | |
| | | information for cost search | |
| Secondary | 53 MB | Extract Unique Search Key | Compressed |
| Processing | | Data, Cost Value Data to | to 0.757% |
| | | generate it as Search Data | level |

The key value is a key value of a search key assigned with a unique key number for each combination of items for search, and for example, when the item is a combination of ‘Customer B, Region A, and Product C,’ it is a unique number of a unique search item indicating it. The cost value for the search item of the combination of ‘Customer B, Region A, and Product C’ can be variously set to L, M, and N each day, respectively. The key value of the search key has the search key number as illustrated in Table 3 described above.

It is possible not only to minimize the redundancy data that daily occurs the same through the search key in order not to be redundant for each combination of a specific search item to optimize the stored data, but also to quickly search for the cost value for the combination of the specific search item.

In addition, the search system 30 searches for the cost data according to the set condition from the search key data of the cost data unit 160 and the daily cost data.

The cost search application 110 inputs a search condition or setting and displays the search UI 111 in which a search result is displayed.

The cost search application 110 searches for the cost data corresponding to the data input through the search UI 111. When the terminal or the service provision system accesses the search system from the outside, the search UI 111 is displayed, and the setting for cost search can be input through the search UI.

Items used for cost search are the items described above, and each item included in the raw cost data can be used for cost search. As each search key is set to each item, it can be used for cost search. For example, in the usage region of the item, when the usage region is Region A, Region B, and Region C, each “Region A,” “Region B,” and “Region C” can be a search key of the item “usage region”. That is, each item of the raw cost data is an item, and the data value of the corresponding item is a search key.

The search for the cost data is performed by the search API 140 according to the input setting. In addition, when the condition for the cost data is set, the filtering unit 130 determines whether or not the cost data to be searched is suitable for the set condition to filter the cost data to thereby derive a result that matches the condition. The filtering unit causes the search result to be filtered and displayed according to the search condition input for the cost search. The search condition can be set in plural.

The search API 140 generates a cost report based on the searched result and applies it to the cost report application 120. The cost report application 120 outputs the cost report.

The filtering unit 130 includes a search filter API 131, a filter structure maker 132, and a search filter analyzer 133.

The search filter API 131 receives the data input through the search UI from the cost search application to cause the search result to be filtered according to the condition.

The filter structure maker 132 performs filtering in response to the input condition. For example, when searching for cost data for a predetermined period for the cost for a specific item, the filter structure maker 132 performs filtering on items and periods (dates).

The search filter analyzer 133 analyzes the searched cost data to determine whether or not it meets the search condition.

Since the search data manager has set the search key upon storing the cost data, the search API firstly searches for the cost data from the search key data 161 based on the search key, and based on the unique search key of the search key according to the search result, the actual daily cost can be searched from the daily billing data 162.

With respect to the input condition, the search filter API can use the items for cost data search, for example, a cloud account, a cloud product, a usage region, a usage duration, a usage cost, a usage unit price, a usage amount, a resource ID, invoice information, a cloud purchase option and the additional information thereon as a search key, such that the search key according to the item can be searched first and the daily cost data corresponding thereto can be searched.

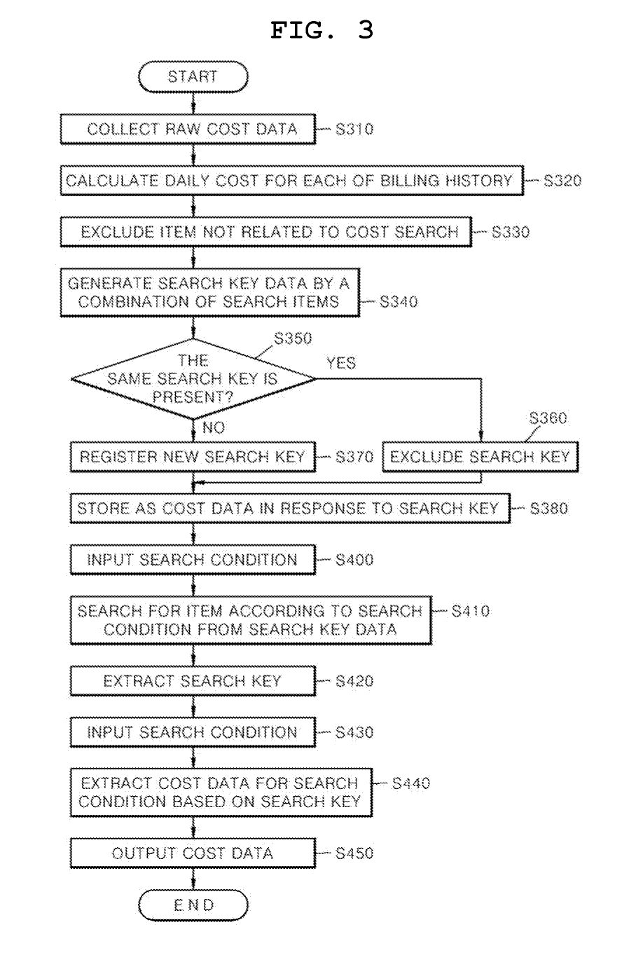

FIG. 3 is a flowchart illustrating a method for processing cost data of an intelligent search system for service cost in accordance with the present disclosure.

As illustrated in FIG. 3, the search system collects raw cost data from at least one cloud service by the raw data collector 153 S310.

The data optimization engine 152 analyzes the billing history of the raw cost data by time and sums them for each of the same billing history to calculate cost information according to the billing history S320. The data optimization engine 152 sums the cost and the usage amount for each of the same billing history based on the hourly log to calculate the daily cost as cost information.

The data optimization engine 152 excludes all data not related to the cost search to reduce the capacity of the data (first optimization) S330.

The search data manager 151 extracts and classifies the items for each of the billing history, and analyzes the billing history or the correlation between the items S340. The search data manager 151 generates search key data using a combination of items having relevancy S340.

In this time, the search data manager can combine the items for search and the additional information items for detailed classification to generate search key data.

For example, the items can use a cloud account, a cloud product, a usage region, a usage duration, a usage cost, a usage unit price, a usage amount, a resource ID, invoice information, and a cloud purchase option.

In addition, the additional information items can use DataTransfer, an OS, a Storage, a Tag, an Auto-Scaling, a Server Type, and a Service Group in order to specifically classify the cost according to the use of the cloud service.

The items extracted from the raw cost data are set with a search key for cost search, respectively. The item for search is to search for the cost by using the previously extracted item and the search key therefor.

The search data manager 151 compares the generated search key data with the previously generated and cumulatively stored search key data to determine whether or not the same search key is present in the cumulatively stored search key data S350.

When the search key is already registered, the search data manager 151 excludes the corresponding search key S360, and registers the new search key in addition to the search key data S370. The search data manager 151 assigns a unique search key of the search key data to the new search key.

In addition, the search data manager 151 extracts the cost information of the same item combination as the search key data from the daily cost of the cost information by day, and stores the cost and usage amount information of the corresponding data in the calendar type table classified into the item of month and day S380.

The search data manager 151 stores cost information to include a search key and a cost value in the calendar type table. The calendar type table includes a unique search key for the search key. Even when the same value is repeatedly registered, the search data manager 151 can be composed of only the search key and the cost value, thus reducing the capacity of the data.

In the search system, the raw cost data is collected periodically, and the cost data is updated by analyzing the collected data.

As described above, as the cost data is stored as a combination of the search key value and the cost value, the search system searches the cost data based on the input search condition.

When the user inputs a search condition, that is, the item and duration for the search through the search UI S400, an item according to the search condition is searched from the search key data S410.

When there is no search key data that matches the item of the search condition, no result and re-search guide are output S420, and when there is search key data that matches the item of the search condition, the unique search key is extracted S430.

The search API and the filtering unit search for the daily cost data from the calendar type table based on the unique search key, and filter it by the date (duration) specified in the search condition to extract the cost data according to the search condition S440.

The extracted cost data is output through the cost search application or the cost report application S450.

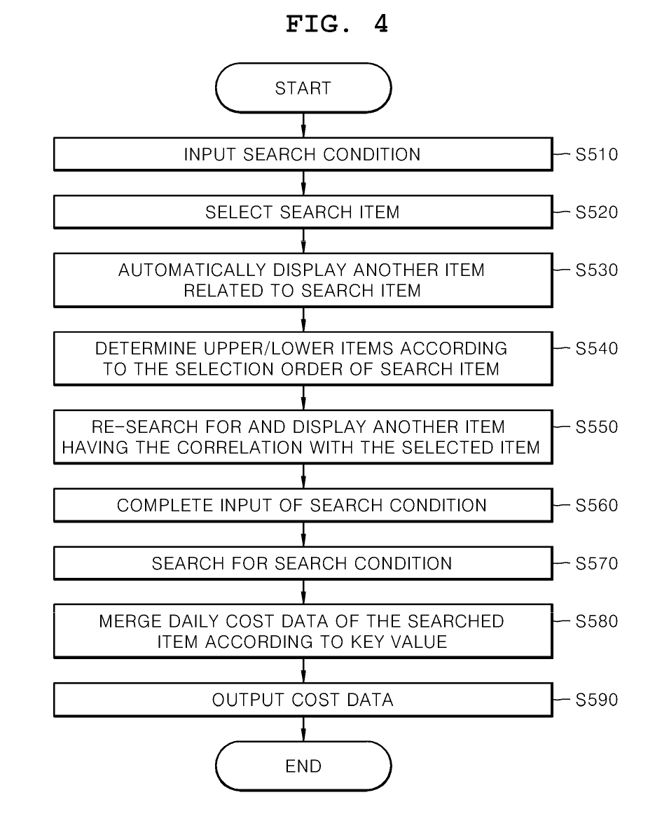

FIG. 4 is a flowchart illustrating a method for searching for cost according to the condition of the intelligent search system for service cost in accordance with the present disclosure.

The method for searching for cost in the search system will be described in more detail as follows.

As illustrated in FIG. 4, a search condition is input for cost search according to the use of the cloud service S510. When the duration of the cost and the value of the item for the search filter are input, the information of the item for which the correlation between items is mapped, for search according to the input search condition is invoked and displayed.

When a value of a specific item is selected from information of an item, for which the correlation between items is mapped, for search S520, the values of other items related to the selected item are searched and the relevant items are automatically displayed S530.

The information of the item for which the correlation therebetween is mapped, for search is displayed on the screen, and displayed on a screen of another item having the correlation therebetween. The items can be displayed hierarchically depending on the relevance therebetween, or the level according to the relevance therebetween can be displayed thereon.

Among the item information for the displayed search, another item related to the item is automatically selected. It is possible not to select an item having the correlation therebetween according to the setting, and also to classify the relevance into levels to select the relevant item by a specified level.

When a plurality of items for search are selected, the upper/lower condition is set according to the order of selection S540. An item to be selected first is set to an upper search condition, and an item to be selected later is set to a lower search condition.

Every time a new item is selected, another item related to the item is searched again and displayed S550.

When all the search conditions are inputted S560, the search condition is searched from the cost data according to the condition of the selected item and duration, etc. S570.

The daily cost data of the searched item is merged or summed according to the key value S580, and the cost data is output S590. The cost data for the searched item is generated as a cost report to be output through the cost report application.

The present disclosure is not necessarily limited to these embodiments, as all the components constituting the embodiment of the present disclosure have been described as being combined and operating together. Within the scope of the present disclosure, depending on the embodiment, all of the components can also operate selectively in combination with one or more.

The above description is merely illustrative of the technical spirit of the present disclosure, and various modifications and changes can be made by those skilled in the art without departing from the essential characteristics of the present disclosure.

What is claimed is:

1. A search system for searching for and managing cost generated by providing service resources based on a cloud service, the search system comprising:
a data management unit for collecting raw cost data comprising information on a usage amount of the time unit for cloud service resources, a usage log, and cost thereby provided from the cloud service to extract each item of billing history included the raw cost data as an item, setting the item as a search key for cost search, and classifying the cost into each item of the billing history to generate cost data;
a cost data unit for storing the cost data;
a cost search application for providing an interface for cost search using the item and cost management for the searched cost including a search UI;
a filtering unit for setting the search key for each item for cost search in response to a search condition input through the search UI, and filtering the result searched from the cost data unit according to the search condition; and
a search unit for generating a cost report based on the cost data included in the filtered searched result.

2. The search system of claim 1, wherein the data management unit comprises:
a data optimization engine for classifying cost data of the time unit into each item from the raw cost data and generating cost information by classifying and summing them by the same item; and
a search data manager for generating a search key for each item for cost search, and storing it in the cost data unit by regenerating the cost data for cost search in response to the search key.

3. The search system of claim 2, wherein the data optimization engine optimizes the capacity of the cost data by excluding the item not used for cost search, and
wherein the search data manager minimizes data to be searched by excluding redundancy data.

4. The search system of claim 2, wherein the search data manager generates search key data by combining the relevant items with respect to the item, and adds a new search key to the search key data by comparing it with the previously generated and cumulatively stored search key data.

5. The search system of claim 2, wherein the search data manager extracts the item and an additional information item for the item to store it together with the cost information therein.

6. The search system of claim 4, wherein the search data manager extracts cost information of a combination of the same items as the search key data by day in the daily cost of the cost information, and stores the cost and usage amount information of the corresponding data in a calendar type table classified into the item of month and day.

7. The search system of claim 2, wherein the search data manager stores only a search key for the item and a cost thereby in a calendar type table when the cost of the same item is repeated.

8. The search system of claim 5, wherein the search data manager extracts a cloud provider, a cloud account, a cloud product, a usage region, a resource ID, invoice information, and a cloud purchase option as the item.

9. The search system of claim 8, wherein the search data manager extracts DataTransfer, an OS, a Storage, a Tag, Auto-Scaling, a Server Type, and a Service Group as the additional information item in order to specifically classify the cost according to the used of cloud service.

10. The search system of claim 2, wherein the search data manager stores the cost data by combining items having mutual relevance based on a predetermined correlation with respect to the item.

11. The search system of claim 2, wherein the filtering unit extracts a search key matching the item by searching for an item included in the search condition from search key data, and extracts daily cost data in response to the search key from the cost data.

12. The search system of claim 10, wherein the search unit automatically searches for and displays another item having the correlation with the item from the item for search when the search condition is input and when a new item is selected, the search unit automatically searches for and displays another item having the correlation with the new item.

13. The search system of claim 10, wherein the search unit searches for cost from the cost data by setting as an upper search condition and a lower search condition according to the order of item selection

14. A method for processing cost data of a search system, comprising:
collecting raw cost data comprising information on a usage amount of the time unit for cloud service resources, a usage log, and cost thereby from at least one cloud service by a data management unit of the search system;
calculating cost information by analyzing the raw cost data, and optimizing cost data by excluding an item not related to cost search by the data management unit;
generating search key data by a combination of items for searching for the raw cost data by the data management unit;
storing the cost information of a combination of the same items as the search key data as cost data by the data management unit;
extracting the cost data by searching for an item included in a search condition from the search key data by a search API when the search condition for cost search is input through a cost search application; and
generating and outputting a cost report according to search results by a cost report application.

15. The method for processing cost data of the search system of claim 14, further comprising:
calculating daily cost for each of billing history by analyzing the raw cost data by the data management unit;
registering a new search key by comparing the search key data with previously generated search key data; and
setting the search key to the cost data.

16. The method for processing cost data of the search system of claim 14, wherein the cost data is stored in a calendar type table by the data management unit.

17. The method for processing cost data of the search system of claim 14, wherein the extracting the cost data further comprises:
extracting a search key matching it by searching for an item from the search key data by the data management unit; and
extracting cost data corresponding to the search key.

18. The method for processing cost data of the search system of claim 14, wherein the extracting the cost data further comprises outputting search results thereof by merging the cost data searched according to a key value of the cost data by the data management unit.
